(19) United States
(12) Patent Application Publication
(10) Pub. No.: US 2024/0255388 A1
(43) Pub. Date: Aug. 1, 2024

(54) METHODS AND APPARATUS FOR PREPARING THIN-FILM SPECIMENS

(71) Applicant: Illinois Tool Works Inc., Glenview, IL (US)

(72) Inventor: Jeffrey Bowser, Norwood, MA (US)

(21) Appl. No.: 18/427,194

(22) Filed: Jan. 30, 2024

Related U.S. Application Data
(60) Provisional application No. 63/442,363, filed on Jan. 31, 2023.

(51) Int. Cl. G01N 1/06

(52) U.S. Cl. CPC G01N 1/06; G01N 2001/063

(57) ABSTRACT

Systems and methods are provided for enhanced thin-film specimen preparation solutions. A cutting device may be used in preparing thin-film specimens. The cutting device may have one or more cutting elements configured to apply uniform cuts into a thin-film specimen sheet as the cutting device is moved over the thin-film specimen sheet. A cutting base may be used to maintain the thin-film specimen sheet in place as the cutting device is moved to apply the cuts. The cutting base may be configured for placement on top of the thin-film specimen sheet. The cutting base and the cutting device are integrated together, or may be separate components. The one or more cutting elements may be rotating blades. The one or more cutting elements may be evenly spaced

### CLAIM OF PRIORITY

This patent application claims priority to and claims benefit from U.S. Provisional Patent Application Ser. No. 63/442,363, filed on Jan. 31, 2023. The above identified application is hereby incorporated herein by reference in its entirety.

### BACKGROUND

This disclosure relates generally to handling of thin-film specimens. More particularly, various implementations in accordance with the present disclosure relate to methods and apparatus for preparing thin-film specimens.

Further limitations and disadvantages of conventional approaches will become apparent to one management of skill in the art, through comparison of such approaches with some aspects of the present method and system set forth in the remainder of this disclosure with reference to the drawings.

### SUMMARY

Aspects of the present disclosure relate to testing solutions and systems for use in conjunction therewith. More specifically, various implementations in accordance with the present disclosure are directed to methods and apparatus for preparing thin-film specimens, substantially as illustrated by or described in connection with at least one of the figures, and as set forth more completely in the claims.

These and other advantages, aspects and novel features of the present disclosure, as well as details of an illustrated implementation thereof, will be more fully understood from the following description and drawings.

### BRIEF DESCRIPTION OF THE DRAWINGS

FIG. 1 illustrates an example apparatus for preparing thin-film specimen.

FIG. 2 illustrates the example apparatus for preparing thin-film specimen from a different perspective.

FIG. 3 illustrates a side view of the example apparatus for preparing thin-film specimen.

FIG. 4 illustrates a bottom view of the example apparatus for preparing thin-film specimen.

FIG. 5 illustrates use of the example apparatus for preparing thin-film specimen.

### DETAILED DESCRIPTION

Various implementations in accordance with the present disclosure are directed to providing enhanced and optimized thin-film handling solutions, particularly with respect to preparing thin-film specimen for use in material testing systems. As used herein, “thin-film specimen” is not limited to specimens of thin films, and may also include specimens of foils or other sheet-like objects that are sufficiently thin as to require careful handling, such as to avoid deforming or otherwise damaging these specimens while being handled. Material testing systems are used to measure physical properties, such as tensile strength or compressive strength, of material specimens. In this regard, use and handling of thin-film specimen require particular care, especially when testing the material properties of thin films. In particular, handling thin-film specimen entails various actions that are particularly challenging, such as preparing of such specimens, and the insertion and alignment of the specimens into a material test system. These actions need to be taken in a manner that does not damage or otherwise affect the quality of the thin-film specimen. However, various challenges and issues may arise with respect to these actions and conventional solutions associated therewith. For example, conventional solutions for preparing thin-film specimen may cause damage to or defects in the prepared specimens. In this regard, edge conditions are very pertinent to the quality of thin-film specimen. As such, providing specimen with as perfect edge as possible is very desirable. However, conventional solutions for preparing thin-film specimen, which typically are knife or blade based (e.g., guillotine-like), tend to cause edge defects.

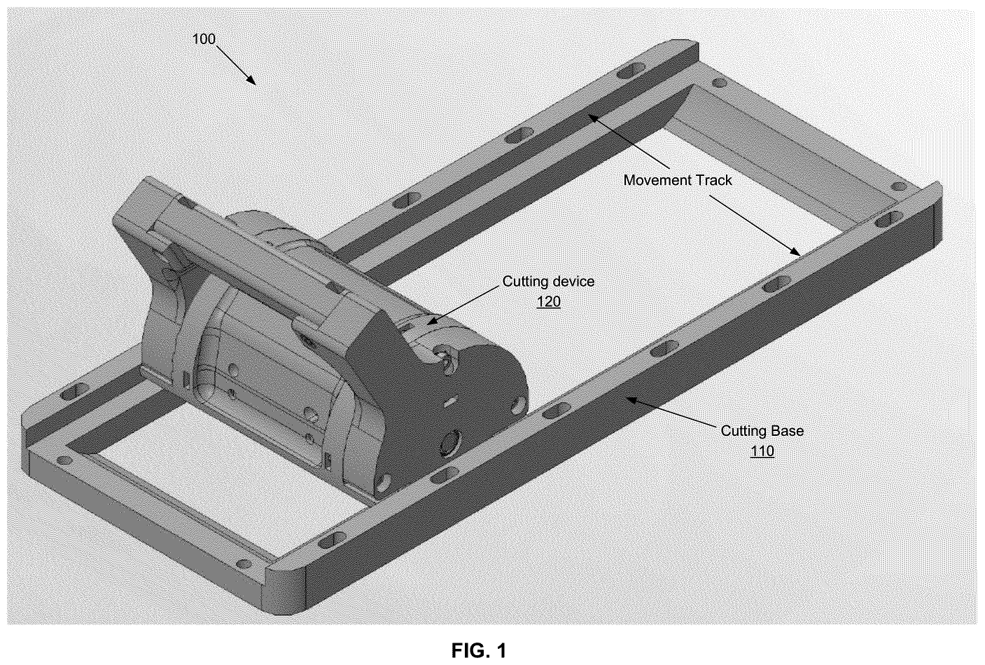

Solutions based on the present disclosure may overcome the limitations and disadvantages of conventional solutions, particularly by use of preparation systems and methods associated therewith that ensure specimen having edges with no defects as may occur when using conventional solutions. In particular, in various example implementations, apparatus based on the present disclosure may use cutting elements that ensure uniform cutting along the length of the specimen. For example, in some example implementations cutting devise with one or more rotating blades (e.g., similar to pizza cutters) may be used, being configured to apply uniform cuts as such devices are, e.g., moved over specimen sheets. In various instances, such cutting devices may comprise a plurality of evenly spaced rotating blades, to provide a number of parallel cuts as the device is moved. An example implementation is illustrated in and described with respect to FIGS. 1-5.

FIG. 1 illustrates an example apparatus for preparing thin-film specimen. Shown in FIG. 1 is apparatus 100 (or parts thereof) that may be used in preparing thin-film specimen. As shown in FIG. 1, the apparatus 100 comprises a cutting base 110 and a cutting device 120.

The apparatus 100 may be configured for facilitating thin-film specimen preparation in enhanced manner, particularly with respect to the cutting of such thin-film specimen (e.g., from thin-film specimen sheets). In this regard, the cutting device 120 may be configured for applying uniform cuts throughout the length of the specimen pieces, thus ensuring edges without the defects or issues that may arise in conventional solutions. This may be done by, e.g., incorporating in the cutting device 120 one or more rotating blades that move freely as the cutting device 120 is moved. The cutting base 110 may be configured to engage the cutting device 120, to facilitate movement of the cutting device 120 as it applies the cuts. For example, the cutting base 110 may be configured as rectangular device or part, with an opening the middle, where the cutting device 120 may be placed and moved. To that end, the cutting base 110 may have flat bottom side/surface for facilitating placement on specimen sheets. Further, the top side of the cutting device 110 may be configured (e.g., cut) such that it incorporate track-like features such that the cutting device 120 may be moved within the opening. In this regard, the track may be designed such that the rotating blades may extend just enough beyond the bottom surface of the cutting base 110 to apply the cuts. Accordingly, the cutting base 110 is designed to keep the cuts straight and parallel as the cutting device 120 is moved over the thin-film specimen (sheet). Further, the cutting base 110 ensures that the cutting device 120 is locked into position relative to the specimen sheet and further ensures that the specimen sheet is held flat without wrinkles during the cutting. In addition, the combination of the cutting device 120 and the cutting base 110 may be configured to control depth of cutting. In this regard, the depth of cutting may be fixed (e.g., based on depth of the track of the cutting base 110). Alternatively, in some implementations, the depth of cutting may be modifiable—e.g., by configuring cutting base 110 such that the depth of the track and/or the overall thickness of the cutting base 110 are adjustable, by configuring the cutting device 120 such that the positioning of the cutting blades is adjustable (e.g., in the vertical direction relative to the cutting surface), etc. The various features of the cutting device 120 and cutting base 110 are shown and described in more detail below.

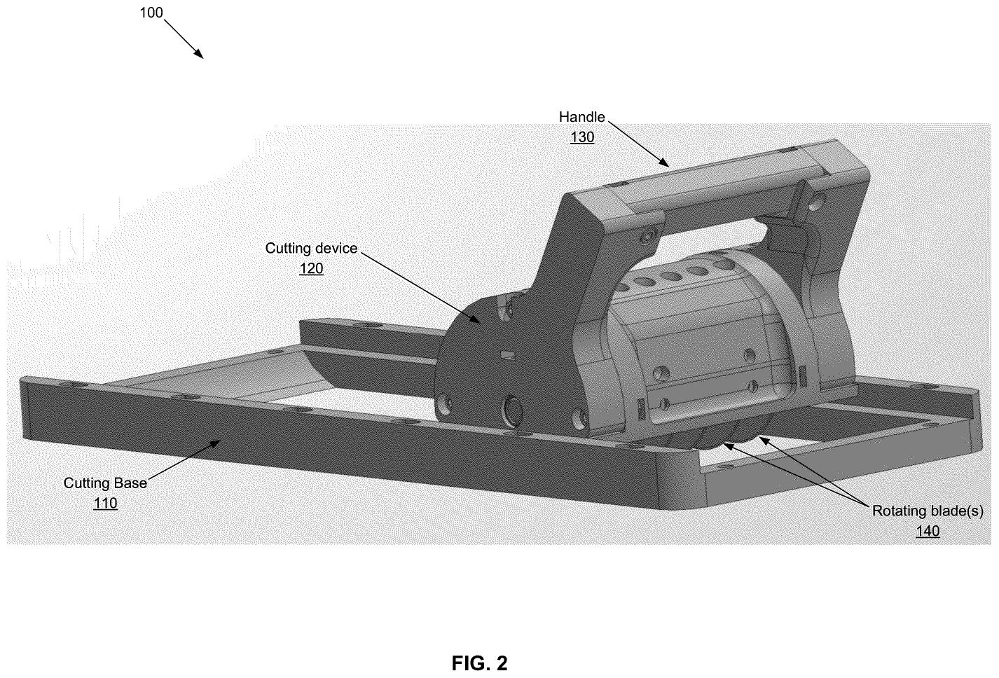

FIG. 2 illustrates the example apparatus for preparing thin-film specimen from a different perspective. Shown in FIG. 2 the apparatus 100 from a different angle, illustrating more components and/or details in the cutting device 120.

In particular, as shown in FIG. 2, the cutting device 120 comprises a handle 130 that the user may use to hold the cutting device 120 and move it within the track on the top side of the cutting base 110. Also shown is a plurality of rotating blades 140 incorporated into the cutting device 120, to make the specimen cuts.

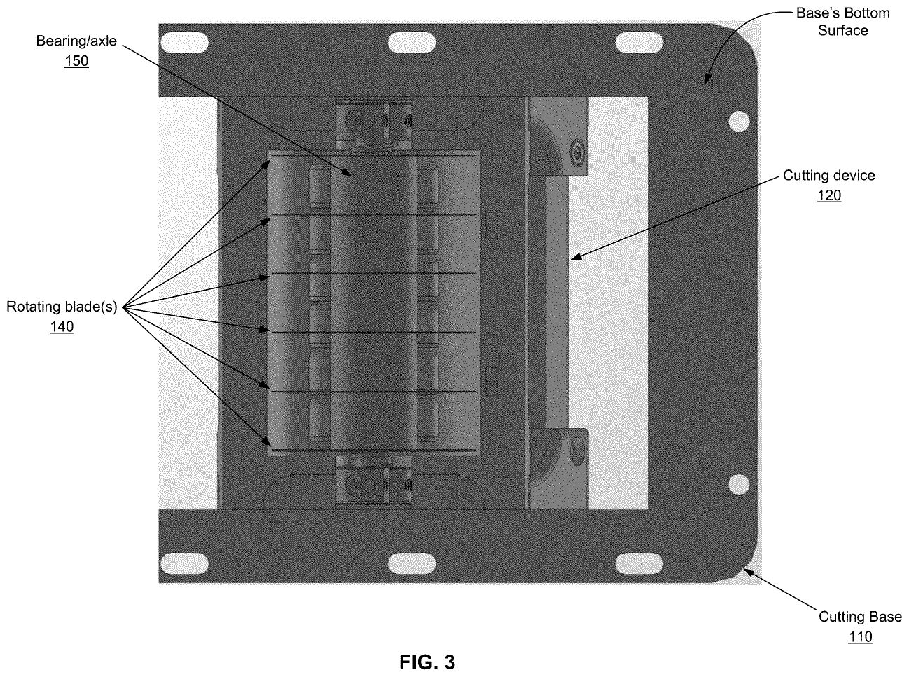

FIG. 3 illustrates a side view of the example apparatus for preparing thin-film specimen. Shown in FIG. 3 the apparatus 100 from the bottom, illustrating more components and/or details in the cutting device 120 and the cutting base 110.

As shown in FIG. 3, the cutting base 110 has a flat bottom side/surface, to enable placing the cutting base 110 flatly—e.g., on a thin-film specimen. Also clearly shown in FIG. 3 are the rotating blades 140. In this regard, the rotating blades 140 are incorporated into a bearing/axle 150, which may be configured to enable relatively free rotation of the rotating blades 140 as the cutting device is moved within the track on the top side of the cutting base 110. While not shown, the cutting device 120 may incorporate additional components (e.g., springs or the like) to maintain the positioning of the rotating blades 140—e.g., spacing between the rotating blades 140, level of the rotating blades 140, etc.

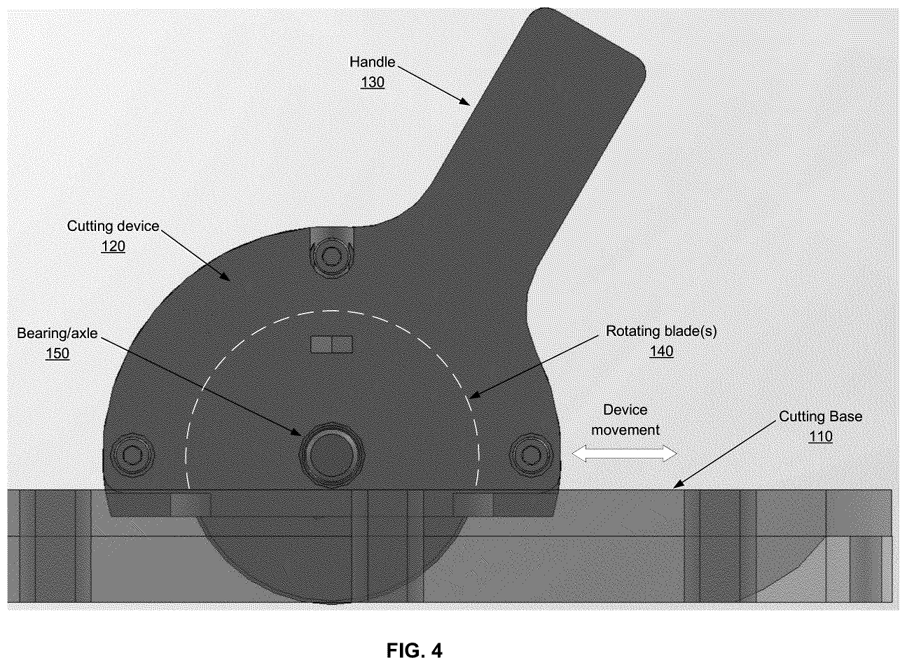

FIG. 4 illustrates a bottom view of the example apparatus for preparing thin-film specimen. Shown in FIG. 4 the apparatus 100 from the side, illustrating more components and/or details in the cutting device 120 and the cutting base 110.

As shown in FIG. 4, the cutting base 110 has a flat bottom side/surface, to enable placing the cutting base 110 flatly—e.g., on a thin-film specimen. Also clearly shown in FIG. 3 are the rotating blades 140. In this regard, the rotating blades 140 are incorporated into a bearing/axle 150, which may be configured to enable relatively free rotation of the rotating blades 140 as the cutting device is moved within the track on the top side of the cutting base 110. While not shown, the cutting device 120 may incorporate additional components (e.g., springs or the like) to maintain the positioning of the rotating blades 140—e.g., spacing between the rotating blades 140, level of the rotating blades 140, etc.

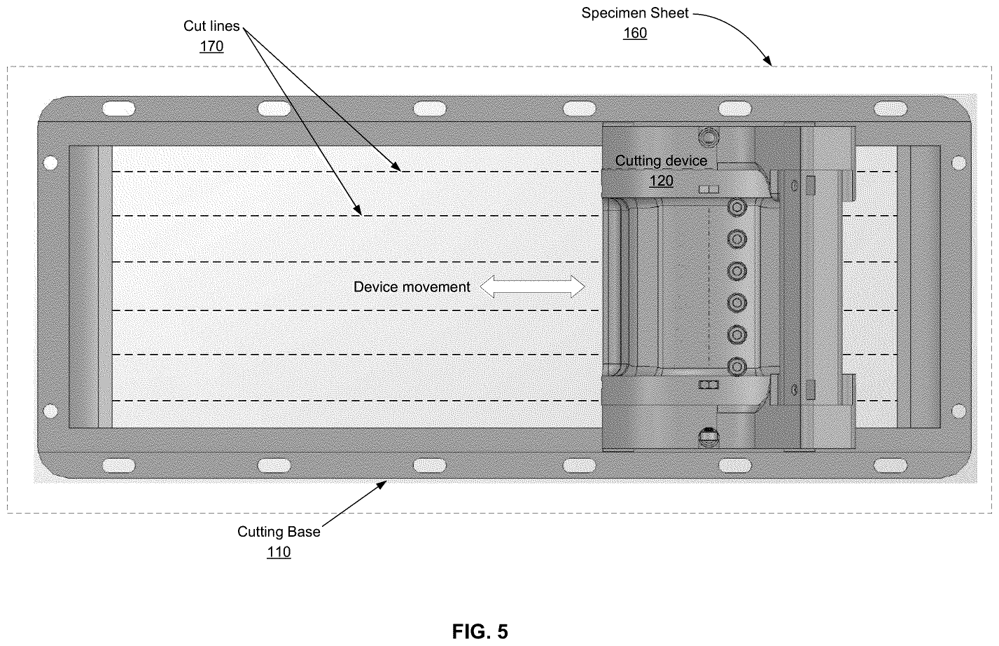

FIG. 5 illustrates use of the example apparatus for preparing thin-film specimen. Shown in FIG. 5 the apparatus 100, and an example use case scenario associated therewith.

In this regard, in the example use case scenario illustrated in FIG. 5, a thin-film specimen sheet 160 is first placed or laid flatly (e.g., on a suitable flat surface). The cutting base 110 is then placed on top of the thin-film specimen sheet 160, with the bottom side/surface of the cutting base 110 applying pressure on the sheet to keep it from moving or otherwise changing shape as it is getting cut. Then, in instances where the cutting device 120 is disconnected from the cutting base 110, the cutting device 120 may be placed within the track on the top side of the cutting base 110. The cutting device 120 may then be moved within the track, which results in the cutting blades 140 applying cuts (or cut lines) 170 into the thin-film specimen sheet 160, thus creating a number of thin-film specimen strips.

Optionally, the extra portions of the thin-film specimen sheet 160 may be cut off (or, alternatively, where there is sufficient sheet left over, the cutting base 110 may be moved over, and more thin-film specimen strips may be made using the cutting device 120.

An example apparatus for preparing thin-film specimens, in accordance with the present disclosure, comprises a cutting device that is configured to cut thin-film specimens, wherein the cutting device comprises one or more cutting elements configured to apply uniform cuts into a thin-film specimen sheet as the cutting device is moved over the thin-film specimen sheet.

In an example embodiment, the apparatus further comprises a cutting base that is configured for placement on top of the thin-film specimen sheet, wherein the cutting base is configured to maintain the thin-film specimen sheet as the cutting device is moved to apply the cuts.

In an example embodiment, the cutting base comprises a track that is enable movement of the cutting device during the applying of the cuts.

In an example embodiment, the cutting base and the cutting device are separate components.

In an example embodiment, the cutting base and the cutting device are integrated together.

In an example embodiment, the cutting device comprises a handle for moving the cutting device when applying the cuts.

In an example embodiment, the one or more cutting elements comprise rotating blades.

In an example embodiment, the one or more cutting elements are evenly spaced.

An example method for preparing thin-film specimens, in accordance with the present disclosure, comprises engaging a thin-film specimen sheet and a cutting device, wherein the cutting device comprises one or more cutting elements configured to apply uniform cuts into the thin-film specimen sheet as the cutting device is moved over the thin-film specimen sheet; and operating the cutting device to create a plurality of thin-film specimen strips from the thin-film specimen.

In an example embodiment, the method further comprises securing the cutting device onto the thin-film specimen sheet during the applying of the uniform cuts.

In an example embodiment, the method further comprises using a cutting base that is configured for placement on top of the thin-film specimen sheet for securing the cutting device onto the thin-film specimen sheet, wherein the cutting base is configured to maintain the thin-film specimen sheet as the cutting device is moved to apply the cuts.

In an example embodiment, the securing comprises placing the cutting base on top of the thin-film specimen sheet.

In an example embodiment, the cutting base and the cutting device are separate components, and the method further comprises engaging the cutting base and the cutting device after placing of the cutting base on top of the thin-film specimen sheet.

In an example embodiment, the cutting base and the cutting device are integrated together into a single device, and the securing comprises placing the single device on top of the thin-film specimen sheet.

In an example embodiment, the cutting device comprises a handle for moving the cutting device when applying the cuts, and operating the cutting device comprises using the handle to move the cutting device over the thin-film specimen sheet.

In an example embodiment, the uniform cuts are evenly spaced.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. For example, as used herein, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other implementations in accordance with the present disclosure may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various implementations in accordance with the present disclosure may be realized in hardware, software, or a combination of hardware and software. The present disclosure may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various implementations in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain implementations, it will be understood by those skilled in the art that various changes may be made and equivalents may be substituted without departing from the scope of the present disclosure. For example, block and/or components of disclosed examples may be combined, divided, re-arranged, and/or otherwise modified. In addition, many modifications may be made to adapt a particular situation or material to the teachings of the present disclosure without departing from its scope. Therefore, it is intended that the present disclosure not be limited to the particular implementation disclosed, but that the present disclosure will include all implementations falling within the scope of the appended claims.

What is claimed is:

1. An apparatus for preparing thin-film specimens, the apparatus comprising:
a cutting device that is configured to cut thin-film specimens,
wherein the cutting device comprises one or more cutting elements configured to apply uniform cuts into a thin-film specimen sheet as the cutting device is moved over the thin-film specimen sheet.

2. The apparatus of claim 1, further comprising a cutting base that is configured for placement on top of the thin-film specimen sheet, wherein the cutting base is configured to maintain the thin-film specimen sheet as the cutting device is moved to apply the cuts.

3. The apparatus of claim 2, wherein the cutting base comprises a track that is enable movement of the cutting device during the applying of the cuts.

4. The apparatus of claim 2, wherein the cutting base and the cutting device are separate components.

5. The apparatus of claim 2, wherein the cutting base and the cutting device are integrated together.

6. The apparatus of claim 1, wherein the cutting device comprises a handle for moving the cutting device when applying the cuts.

7. The apparatus of claim 1, wherein the one or more cutting elements comprise rotating blades.

8. The apparatus of claim 1, wherein the one or more cutting elements are evenly spaced.

9. An method for preparing thin-film specimens, the method comprising:
engaging a thin-film specimen sheet and a cutting device,
wherein the cutting device comprises one or more cutting elements configured to apply uniform cuts into the thin-film specimen sheet as the cutting device is moved over the thin-film specimen sheet; and
operating the cutting device to create a plurality of thin-film specimen strips from the thin-film specimen.

10. The method of claim 9, further comprising securing the cutting device onto the thin-film specimen sheet during the applying of the uniform cuts.

11. The method of claim 10, further comprising using a cutting base that is configured for placement on top of the thin-film specimen sheet for securing the cutting device onto the thin-film specimen sheet, wherein the cutting base is configured to maintain the thin-film specimen sheet as the cutting device is moved to apply the cuts.

12. The method of claim 11, wherein the securing comprises placing the cutting base on top of the thin-film specimen sheet.

13. The method of claim 11, wherein the cutting base and the cutting device are separate components, and further comprising engaging the cutting base and the cutting device after placing of the cutting base on top of the thin-film specimen sheet.

14. The method of claim 11, wherein the cutting base and the cutting device are integrated together into a single device, and wherein the securing comprises placing the single device on top of the thin-film specimen sheet.

15. The method of claim 9, wherein the cutting device comprises a handle for moving the cutting device when applying the cuts, and wherein operating the cutting device comprises using the handle to move the cutting device over the thin-film specimen sheet.

16. The method of claim 1, wherein the uniform cuts are evenly spaced.
